(19) United States
(12) Patent Application Publication
(10) Pub. No.: US 2011/0209928 A1
(43) Pub. Date: Sep. 1, 2011

(54) REMOTE CONTROL

(75) Inventors: TING LUO, Shenzhen City (CN); XIAN-WEI MA, Shenzhen City (CN)

(73) Assignees: HONG FU JIN PRECISION INDUSTRY (ShenZhen) CO., LTD ., Tu-Cheng (CN); HON HAI PRECISION INDUSTRY CO., LTD., Tu-Cheng (TW)

(21) Appl. No.: 12/770,764

(22) Filed: Apr. 30, 2010

(30) Foreign Application Priority Data
Feb. 26, 2010 (CN) 201010114964.0

(51) Int. Cl. G06F 3/041

(52) U.S. Cl. 178/18.03

(57) ABSTRACT

A remote control capable of indicating which electronic device controlled by the remote control is in use is provided. A remote control includes a microprocessor, a touch panel with a plurality of contact areas, and a state indication unit. Each of the contact areas is labeled with one color and each of the contact areas is configured to control one electronic device; the state indication unit is configured to indicate which of the electronic devices is in the on state; the microprocessor controls whether to turn on one electronic device based on the contact operation on each of the contact areas, and directs the state indication unit to display the color of the determined contact areas in relation to the electronic devices.

### BACKGROUND

1. Technical Field

The present disclosure relates to remote controls and, particularly, to a remote control capable of indicating which electronic device controlled by the remote control is in use or not.

2. Description of Related Art

A commonly used remote control provides no indication of the on or off status of devices it controls. As a result, use of the devices is unnecessarily complicated and inconvenient.

### BRIEF DESCRIPTION OF THE DRAWINGS

The components of the drawings are not necessarily drawn to scale, the emphasis instead being placed upon clearly illustrating the principles of a remote control. Moreover, in the drawings, like reference numerals designate corresponding parts throughout multiple views.

FIG. 1 is a block diagram of a remote control in accordance with an exemplary embodiment.

FIG. 2 is a schematic view showing an indication state of the remote control of FIG. 1.

FIG. 3 and FIG. 4 are schematic views of the indication state of a remote control in accordance with a second exemplary embodiment.

### DETAILED DESCRIPTION

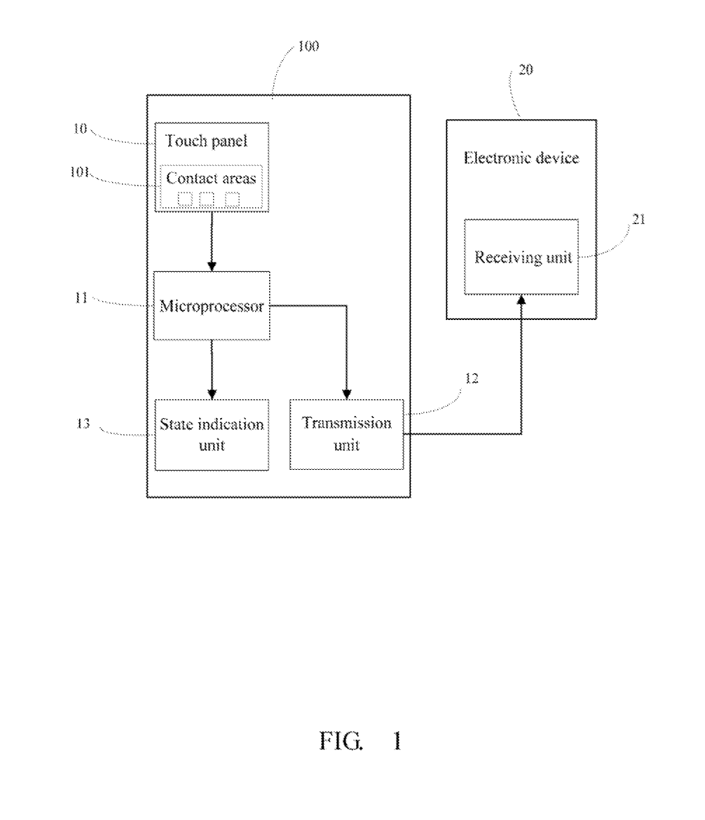

Referring to FIG. 1, a remote control 100 configured to control a plurality of electronic devices 20 is illustrated. The remote control 100 includes a touch panel 10, a state indication unit 13, a microprocessor 11, and a transmission unit 12.

The touch panel 10 includes a plurality of contact areas 101 and transmits a plurality of contact signals to the microprocessor 11. In the embodiment, each of the contact areas 101 is an annular ring concentric with other contact areas 101. The state indication unit 13 is surrounded by the contact areas 101. Each of the contact areas 101 corresponds to one electronic device 20 to be controlled by the remote control. A first sliding contact operation on at least one of the contact areas 101 turns on the electronic device 20 corresponding to the contact area. A second sliding contact operation on at least one of the contact areas 101 turns off the electronic device 20 corresponding to the most recently active contact area 101. Various contact operations on a contact area 101 turn a corresponding electronic device 20 on or off or adjusts properties of the electronic device 20.

For example, first sliding contact from one of the contact areas 101 to the contact area 101 adjacent to the state indication unit 13 is detected as a first sliding contact operation determined. Sliding contact from the contact area 101 adjacent to the state indication unit 13 to one of the contact areas 101 can be determined as a second sliding contact operation. Click contact on one of the contact areas 101 can turn a corresponding electronic device 20 on or off corresponding to the contact area 101 being determined. In the embodiment, each of the contact areas 101 is labeled with a distinguishing color.

The state indication unit 13 is configured to indicate which electronic device 20 is in use or not. In the embodiment, if electronic device 20 is turned on, the state indication unit 13 indicates the same by displaying the distinguishing color of. the electronic device 20 in the touch area; if electronic device 20 is turned off, the state indication unit 13 does not indicate the color of. the electronic device 20 in the touch area.

The microprocessor 11 is configured for determining which of the contact areas 101 is contacted, and the type of contact operation executed on the touch panel 10 in response to the contact signal transmitted. When the first sliding contact operation is determined, the microprocessor 11 determines the contacted contact area 101 and generates an open signal to turn on the electronic device 20 corresponding to the firstly contacted contact area 101. The microprocessor 11 further directs the state indication unit 13 to display color of the contacted contact area 101 to indicate that the corresponding electronic device 20 is in use. When the second sliding contact operation is determined, the microprocessor 11 determines the most recently contacted contact area 101 and generates a close signal to turn off the corresponding electronic device 20. The microprocessor 11 further directs the state indication unit 13 to stop displaying the color of the most recently contacted contact area 101, for example, after a preset period of time has elapsed. When one contact operation for adjusting properties is determined, the microprocessor 11 generates a corresponding control signal to adjust one property of the electronic device 10 corresponding to the contacted contact area 101.

The transmission unit 12 is configured for transmitting signals sent from the microprocessor 11 to a receiving unit 21 of the electronic device 20 to be controlled.

In a first embodiment, each of the contact areas 101 is independent from others, and the contact areas 101 cooperatively forms the touch panel 10. Each of the contact areas 101 has an independent coordinate system to identify a touch point of the contact area. The contact signal generated by each of the contact areas 101 is labeled with one identifier. Each of the contact areas 101 includes a plurality of touch points. Each of the touch points is assigned with identifying coordinates. The microprocessor 11 determines which of the contact areas 101 is contacted according to the identifiers, and determines the type of contact operations on the touch panel 10 according to the coordinates of the contact signal.

In a second embodiment, the touch panel 10 is a single panel divided into a plurality of contact areas 101. The touch panel 10 corresponds to a single coordinate system. Each touch point of the touch panel 10 is assigned with identifying coordinates. The coordinates of the touch points of each contact area 101 form a coordinate cluster. For example, when the coordinate system is a Descartes coordinate system, the coordinates of each touch point are Xᵢ, Yⱼ. When the contact areas 101 are concentrically circular rings, the coordinates satisfying Xᵢ²+Yⱼ²<=Rᵢ² are classified as one coordinate cluster, wherein the semi-diameter Rᵢ is the maximum among the semi-diameters of the contact area 101.

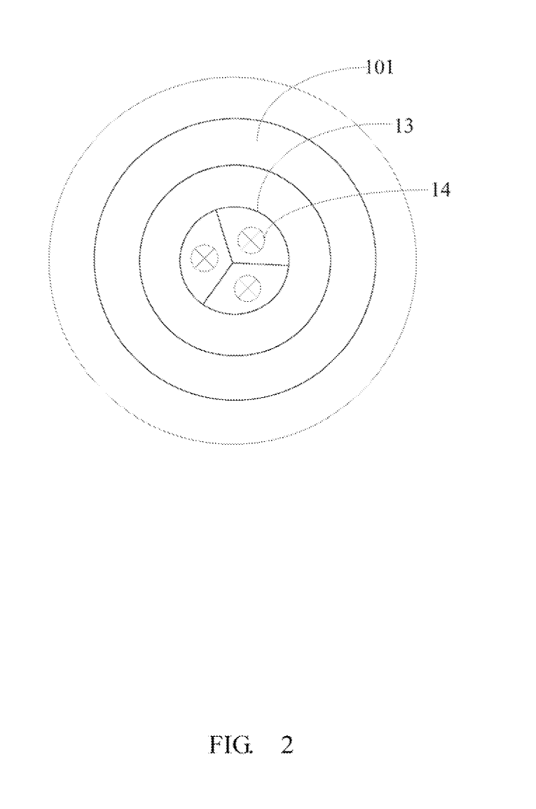

Referring to FIG. 2, in a first embodiment, the state indication unit 13 includes a plurality of indicators 14. Each of the indicators 14 corresponds to one contact area 101. That is, the color of each of the indicators is 14 the same as the color of one contact area 101. In the first embodiment, the indicators 14 are covered by a transparent panel (not shown). When electronic device 20 is determined to be turned on, the microprocessor 11 lights a corresponding indicator 14. When electronic device 20 is determined to be turned off, the microprocessor 11 turns off the corresponding indicator 14. It should be noted that if multiple electronic devices 20 are turned on, a corresponding number of the indicators 14 corresponding to the electronic devices 20 are lit.

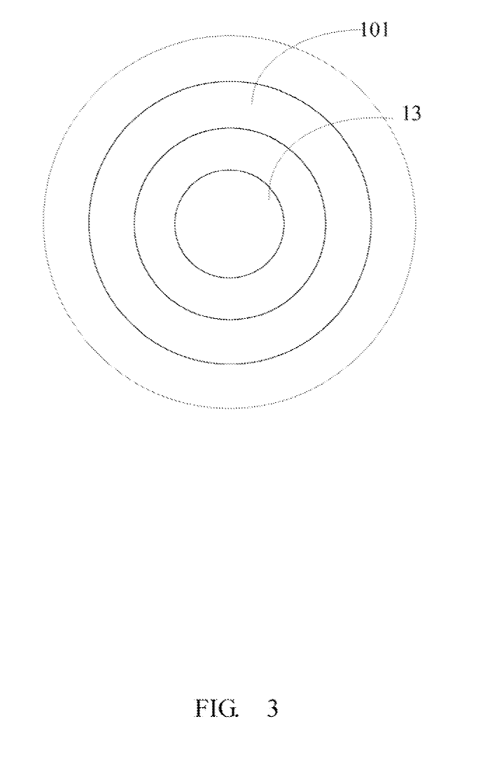

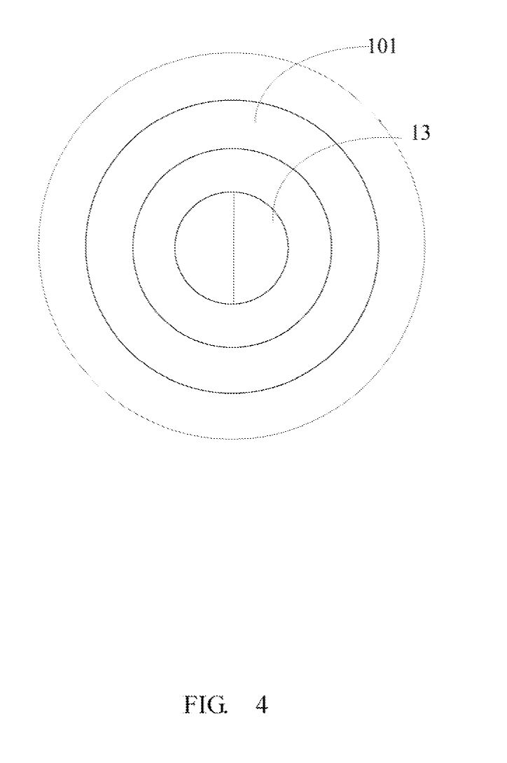

Referring to FIG. 3 and FIG. 4, in a second embodiment, the state indication unit 13 includes a display screen. When electronic device 20 is determined to be turned on, the microprocessor 11 directs the display screen to display the same color as the contact area 101 corresponding to the electronic device 20. When electronic device 20 is determined to be turned off, the microprocessor 11 directs the display screen to stop displaying the same color as the contact area 101 corresponding to the electronic device 20. It should be noted that if multiple electronic devices 20 are turned on, the display screen displays a corresponding number of distinguishing colors corresponding to the contact areas 101 accordingly. For example, if one electronic devices 20 is turned on, the display screen displays one color corresponding to the contact areas 101 as full screen; if two electronic devices 20 are turned on, the display screen displays two color corresponding to the contact areas 101, wherein the display screen is divided into two areas averagely, each of the two areas indicates one color of the contacted contact areas 101.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A remote control, comprising:
a touch panel configured for generating contact signals in response to contact, wherein the touch panel comprises a plurality of contact areas, each of the contact areas labeled with a distinguishing color, and each of the contact areas corresponding to one electronic device to be controlled by the remote control;
a state indication unit configured for displaying one or more distinguishing colors corresponding to one or more of the contact areas; and
a microprocessor configured for determining which contact areas are contacted, and which type of contact operation is selected on the touch panel in response to the contact signal transmitted from the touch panel, and further configured for controlling the state indication unit to display the distinguishing colors corresponding to the contacted contact areas.

2. The remote control as described in claim 1, wherein each of the contact areas is an annular ring concentric with other contact areas, and the state indication unit is surrounded by the contact areas.

3. The remote control as described in claim 2, wherein each of the contact areas is independent from the others, and the contact areas cooperatively form the touch panel, and each of the contact areas has an independent coordinate system to identify a touch point of the contact area.

4. The remote control as described in claim 2, wherein the touch panel is a single panel and is divided into a plurality of areas as the contact areas, and the touch panel corresponds to a single coordinate system to identify a touch point of the contact area.

5. The remote control as described in claim 1, wherein a type of contact operations on a single contact area is configured to adjust properties of one electronic device corresponding to the one of the contact areas.

6. The remote control as described in claim 1, wherein the state indication unit includes a plurality of indicators, each of the indicators corresponds to one contact area that is, the color of each of the indicators is the same as the color of one contact area.

7. The remote control as described in claim 1, wherein the state indication unit includes a display screen, when the electronic device is determined to be turned on, the microprocessor directs the display screen to display a color the same as that of the contact area corresponding to the electronic device.
